(19) United States
(12) Patent Application Publication
(10) Pub. No.: US 2008/0114783 A1
(43) Pub. Date: May 15, 2008

(54) METHOD, SYSTEM, AND PROGRAM PRODUCT FOR MANAGING A PROCESS AND IT INTERLOCK

(76) Inventors: Tien M. Nguyen, Columbia, MD (US); Jay K. Strosnider, Chapel Hill, NC (US)

Correspondence Address: HOFFMAN, WARNICK & D'ALESSANDRO LLC, 75 STATE ST, 14TH FLOOR, ALBANY, NY, 12207, US

(21) Appl. No.: 11/559,916

(22) Filed: Nov. 15, 2006

(51) Int. Cl. G06F 17/30; G06Q 10/00

(52) U.S. Cl. 707/100; 705/7; 707/E17.005

(57) ABSTRACT

The present invention features multiple ideas that enable building and maintaining process scorecard models for a large number of process variations; process reference scorecard models and process/IT scorecard delta models. Specifically, the present invention provides a solution for managing a process and IT interlock. Under this solution a tabular model of a process having process steps along a first axis and process variations along a second axis, with cells at the intersections of the axes is constructed. Process step details including IT details for a base process are populated into the cells of a first row of the second axis. Delta details (to-be base cases) of the process steps for each of the process variations are populated into additional rows of the second axis. Project management status indicators are enabled for each cell to denote statuses of the process steps in each cell.

### BACKGROUND OF THE INVENTION

1. Field of the Invention

The present invention generally relates to process management. Specifically, the present invention relates to a method, system, and program product for managing a process and IT interlock.

2. Related Art

In the corporate world, Information Technology (IT) is often used to manage business processes. Each process typically includes a set (one or more) of steps for which various issues actions, and other needs/goals need to be tracked. Moreover, it is common for multiple processes to exist as a process family. Given that many levels of complexity can arise with such possibilities, one needs to be able to construct a concentrated view in order to perform comparisons across various the perspectives.

For example, a project management perspective is driving a quickly interlock the many procurement process variations with differing IT systems around the world. Moreover, an approach is needed to assess progress to completion of jobs. Such an approach should quickly identify all the new IT and Process requirements tying them back to the process steps. Still yet, such an approach should provide easy way to manage interlock actions and issues to facilitate driving to closure.

Existing approaches fail to provide common process reference models and a compact representation. As such, it is essentially impossible to systematically compare processes as they are simply to big and bulky and do not lend themselves to systematic comparison. In addition, it should be further noted that there is no “delta model” representation in any of the existing process modeling tools. The “delta model” concept below is critical and is not supported in any tools out there.

In view of the foregoing, there exists a need for a solution that solves at least one of the deficiencies of the related art.

### SUMMARY OF THE INVENTION

The present invention features multiple ideas that enable building and maintaining process scorecard models for a large number of process variations; process reference scorecard models and process/IT scorecard delta models. Specifically, the present invention provides a solution for managing a process and IT interlock. Under this solution a tabular model of a process having process steps along a first axis and process variations along a second axis, with cells at the intersections of the axes is constructed. Process step details including IT details for a base process are populated into the cells of a first row of the second axis. Delta details (to-be base cases) of the process steps for each of the process variations are populated into additional rows of the second axis. Project management status indicators are enabled for each cell to denote statuses of the process steps in each cell.

Along these lines, the tabular model is realized and displayed by a spreadsheet program. The process can be part of a process family that is represented by different tabs of the tabular model. In addition populating as-is base cases pertaining to Information Technology (IT) changes and procedure changes are populated into the cells. In general, the project management status indicators can be any type of formatting or symbols that denote the various statuses. For example a set of colors could be employed where the color red denotes an issue needing resolution; the color yellow denotes an action being open; and the color green denoting that IT interlock has been achieved. Still yet, computer architecture decisions and exceptions; and an IT micro summary (identifying applications and their micro-flows within the process steps) can be populated in the cells, while denoting on-demand opportunities can be denoted in the cells.

A first aspect of the present invention provides a method for managing a process and IT interlock, comprising: constructing a tabular model of a process having process steps along a first axis and process variations along a second axis, with cells at the intersections of the axes; populating process step details including IT details for a base process into the cells of a first row of the second axis; populating delta details of the process steps for each of the process variations into additional rows of the second axis; and enabling project management status indicators for each cell denoting statuses of the process steps in each cell.

A second aspect of the present invention provides a system for managing a process and IT interlock, comprising: means for constructing a tabular model of a process having process steps along a first axis and process variations along a second axis, with cells at the intersections of the axes; means for populating process step details including IT details for a base process into the cells of a first row of the second axis; means for populating delta details of the process steps for each of the process variations into additional rows of the second axis; and means for enabling project management status indicators for each cell denoting statuses of the process steps in each cell.

A third aspect of the present invention provides a program product stored on a computer readable medium for managing a process and IT interlock, the program product comprising program code for causing a computer system to: construct a tabular model of a process having process steps along a first axis and process variations along a second axis, with cells at the intersections of the axes; populate process step details including IT details for a base process into the cells of a first row of the second axis; populate delta details of the process steps for each of the process variations into additional rows of the second axis; and enable project management status indicators for each cell denoting statuses of the process steps in each cell.

A fourth aspect of the present invention provides a computer software embodied in a propagated signal for managing a process and IT interlock, the computer software comprising instructions for causing a computer system to: construct a tabular model of a process having process steps along a first axis and process variations along a second axis, with cells at the intersections of the axes; populate process step details including IT details for a base process into the cells of a first row of the second axis; populate delta details of the process steps for each of the process variations into additional rows of the second axis; and enable project management status indicators for each cell denoting statuses of the process steps in each cell.

A fifth aspect of the present invention provides a method for deploying a system for managing a process and IT interlock, comprising: providing a computer infrastructure being operable to: construct a tabular model of a process having process steps along a first axis and process variations along a second axis, with cells at the intersections of the axes; populate process step details including IT details for a base process into the cells of a first row of the second axis; populate delta details of the process steps for each of the process variations into additional rows of the second axis; and enable project management status indicators for each cell denoting statuses of the process steps in each cell.

A sixth aspect of the present invention provides a data processing system for managing a process and IT interlock, comprising: a memory medium; a bus coupled to the memory medium; and a processor coupled to the bus, the memory medium comprising computer program code for causing the processor to: construct a tabular model of a process having process steps along a first axis and process variations along a second axis, with cells at the intersections of the axes; populate process step details including IT details for a base process into the cells of a first row of the second axis; populate delta details of the process steps for each of the process variations into additional rows of the second axis; and enable project management status indicators for each cell denoting statuses of the process steps in each cell.

Therefore, the present invention provides a solution for managing a process and IT interlock.

### BRIEF DESCRIPTION OF THE DRAWINGS

The foregoing and other exemplary purposes, aspects and advantages will be better understood from the following detailed description of an exemplary embodiment of the invention with reference to the drawings.

FIG. 1 depicts an illustrative business process reference model according to the present invention.

FIG. 2 depicts illustrative business process concepts according to the present invention.

FIG. 3 depicts an illustrative tracking of IT changes according to the present invention.

FIG. 4 depicts the tracking of process changes according to the present invention.

FIG. 5 depicts illustrative project management concepts according to the present invention.

FIG. 6 depicts illustrative architecture concepts represented in a score card according to the present invention.

FIG. 7 depicts illustrative annotations and descriptions for architecture exceptions according to the present invention.

FIG. 8 depicts illustrative applications in IT micro summary according to the present invention.

FIG. 9 depicts illustrative on-demand concepts according to the present invention.

FIG. 10 depicts illustrative annotations and descriptions for on-demand opportunities exceptions according to the present invention.

FIGS. 11A-B depicts an illustrative process scorecard model flowchart according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience the Detailed Description of the Invention has the following Sections:

I. Definitions

II. General Description

III. Illustrative Embodiment

### I. Definitions

For the purposes of this disclosure, the following terms are defined as indicated below:

Business Process Model is a representation describing the properties of a real or imagined business process.

Business Process Family or Process Family is a group of related processes typically grouped by common business function.

Process Scorecard Model is a tabular Business Process Model attributed with project management concepts. The column headings are the generic process steps organized in their natural process order with functional clustering as appropriate. Note there is no explicit control flow description in a Process Scorecard Model.

Process/IT Scorecard Model is a Process Scorecard Model attributed with IT micro descriptions and Process/IT interlock concepts.

“On-Demand” Process/IT Scorecard Model is a Process/IT Scorecard Model further attributed to score the “on demand” posture of the business processes under consideration.

Process Reference Scorecard Model is a generic Process Scorecard Model enabling:
rapid construction of Process Scorecard Models,
process and IT comparisons across process variations.

### A particular Process Reference Scorecard Model applies to a single Process Family.

Process/IT Scorecard Base Models or Base Models are the Process/IT Scorecard Models ground one to many Delta Models. There at least two Base Models corresponding to the “as is” and “to be” base models for a process family and it's associated IT implementations.

Process/IT Scorecard Delta Models or Delta Models are short-hand Process/IT Scorecard Models with only the differences relative to the base models called out.

### II. General Description

As indicated above, the present invention features multiple ideas that enable building and maintaining process scorecard models for a large number of process variations; process reference scorecard models and process/IT scorecard delta models. Specifically, the present invention provides a solution for managing a process and IT interlock. Under this solution, a tabular model of a process having process steps along a first axis and process variations along a second axis, with cells at the intersections of the axes is constructed. Process step details including IT details for a base process are populated into the cells of a first row of the second axis. Delta details (to-be base cases) of the process steps for each of the process variations are populated into additional rows of the second axis. Project management status indicators are enabled for each cell to denote statuses of the process steps in each cell.

Along these lines, the tabular model is realized and displayed by a spreadsheet program. The process can be part of a process family that is represented by different tabs of the tabular model. In addition populating as-is base cases pertaining to Information Technology (IT) changes and procedure changes are populated into the cells. In general, the project management status indicators can be any type of formatting or symbols that denote the various statuses. For example a set of colors could be employed where the color red denotes an issue needing resolution; the color yellow denotes an action being open; and the color green denoting that IT interlock has been achieved. Still yet, computer architecture decisions and exceptions; and an IT micro summary (identifying applications and their micro-flows within the process steps) can be populated in the cells, while denoting on-demand opportunities can be denoted in the cells. It should be understood that an illustrative example set forth below describes the present invention in the context of a procurement process. However, it should be appreciated that the present invention is not limited to such an example. Rather, the present invention could be used to manage any type of process.

In any event, Process Reference Scorecard Models are generic Process Scorecard Model enabling:
rapid construction of Process Scorecard Models,
process and IT comparisons across process variations.

### A particular Process Reference Scorecard Model applies to a single Process Family.

Process Reference Scorecard Models are ready-made, generic process reference models expediting the construction of detailed process scorecards. The Process Reference Scorecard Models provide the primary organizing principle for the method. Processes show up as tabs in the scorecard with the column headings being the generic process steps organized in their natural process order with functional clustering as appropriate. The reference models enable rapid construction of Process Scorecard Models versus building from scratch. Note the process scorecards are tabular with columns as process steps in natural process order. The process scorecards do not specify explicit process control flow. One would need a full process model for the control flow. Ideally, the scorecard would be a report generated out of a process modeling tool such as WebSphere Business Integration (WBI) Modeler, which is commercially available from IBM Corp. of Armonk, N.Y. (IBM, WebSphere, WBI, and related terms are trademarks of IBM Corp. in the United States and/or other countries). However, there is very large value in being able to construct process scorecard models directly when the underlying detailed process models to not exist. This is the normal case. Further, it is often the case that the fidelity offered by the scorecards models is sufficient for most business transformation activities.

In the case of procurement models, a generic procurement Process Reference Scorecard Model was used. All process scorecards were constructed against the same reference model. One needs only constructs only two base Process/IT implementation models; the “as is” worldwide process/IT implementation model and the “to be” worldwide” process/IT implementation model. Each model is constructed on top of the reference model.

Process/IT Scorecard Delta Models or Delta Models are short-hand Process/IT Scorecard Models that include only the differences relative to the Base Models called out. Delta models dramatically reduce modeling time (one or more orders of magnitude) enabling one to systematically model the large number of process family variations. Note, it has the further benefit of explicitly highlighting the differences. For business transformation the differences are your focus areas.

The invention's Process Reference Scorecard Models also enables systematic comparison of the many variations within a process family. All Scorecard Models align to the single reference model enabling comparisons. One builds two Base Models “as is” and “to be” Process/IT Base Scorecard Models on top of the Process Reference Scorecard Model. The Delta models for all the variations directly highlight the difference providing the essential comparisons directly. One only sees the differences. The Delta Models that provide a direct, systematic means to compare a large number of process variations.

The invention also provides a compact and/or integrated representation for viewing large set of process variations from multiple perspectives:

### Business Process Concepts:

Process Reference Scorecard Models provide the primary organizing principle for the method. Processes show up as tabs in the scorecard with the column headings being the generic process steps organized in their natural process order with functional clustering as appropriate.
“As Is” and “To Be” Process/IT Scorecard Model pairs show up as adjacent rows in the representation model. The “As Is” provides the change base case.
“To Be” Process/IT Base Scorecard Models provide the base case for the shorthand delta modeling of “to be” processes and supporting IT. One either assigns a specific “To Be” Process/IT Scorecard Model as the base case or alternatively may enter the strategic blueprint implementation as the base case.
Process/IT Scorecard Delta Models provides a shorthand means to very quickly identify differences across a set of related “to be” processes. One only calls out the differences saving time. IT changes (ITCs) and Manual Procedure Changes (MPCs) are changes relative to “as is” base for IT and procedures respectively.

### Project Management Concepts:

Red, Yellow, and Green: RYG visually tells the PM whether process step is interlocked with IT. Process is fully interlocked when all process step cells are green.
Actions: All yellow cells must have associated actions to close process/IT interlock.
Issues: All red cell must have associated issue owners and plans to close.
IT Changes (ITC's): ITC's identify the new system requirements and link them back to the process step/function requiring the change. The set of ITC's are the high-level system requirements for the business transformation. The project plan must then size the changes and interlock development, test and deployment of the IT changes.
Manual Procedure Changes (MPC's): MPC's identify the manual procedural changes and link them back to the process step needing the change. The set of MPC's capture the set of process changes required to support the business transformation. Completing these procedure changes and interlocking them with the IT changes is the basis of an interlocked process/IT transformation plan.

### Architecture Concepts:

IT Micro Summary is a short hand notation identifying the applications and their micro-flows within the process step cells. One can then quickly see what applications support what process steps.
Application Impact Summary Table provides a view of the in scope applications with linkages to the ITC's that impact the applications.
Architecture Decisions (AD #) capture all architecture decisions within the business process context.
Architecture Exceptions (AE #) identify process/IT design points that are inconsistent with basic architecture principles or strategic architecture directions.

### “On Demand” Concepts:

On Demand Opportunities (ODEs) identify process/IT design points with high potential for “On Demand” transformation.
On Demand Exceptions (ODEs) identify process/IT design points that are inconsistent IBM's “On Demand” strategy.

### The “On Demand” Process/IT Interlock Scorecard provides a business transformation management view of process/IT interlock through the “on demand” lens.

The invention representation(s) combines key project management, business process, IT architecture and “on demand” concepts into a simple, light-weight method easily used by practitioners and understood by the management team. Little to no training is required. The invention's Delta Models greatly reduce model building time and facilitate focusing in on the key differences across process and IT implementations the process families and their many variations. For example: (1) determining the difference between base U.S. workstation procurement process/IT and the workstation procurement process/IT in Spain or Japan; and (2) determining the difference between “authentication IT support” for employee workstation procurement versus “authentication IT support” for Strategic Outsourcing procurement. While invention is typically embodied as a table or spreadsheet, it could be implemented as a set of “prefabricated” extensions/reports out of the WBI Modeler tool.

### III. Illustrative Example

These concepts will be described in greater detail in the context of an illustrative example involving the decoupling of computer procurement processes within a company “A” pursuant to the sale of a personal computer manufacturing operation within company “A” to company “B”. In this example, an expedient approach was used to get to Day 1. There were 15 major variations of the procurement process ranging from purchasing employee workstations to strategic outsourcing procurement to donations. Add to this the 66 countries that company does business in and there was essentially 990 procurement processes variations to interlock. As is generally the case, the “as is” process models do not exist or have not been maintained. Given the executive mandated time constraint to complete the separation, there was no way that any significant amount of conventional process modeling could be completed. Clearly some sort of short cut was needed. Consider now if one had the set of 990 models of the procurement process variations. Each model is a large representation. Prior to the present invention, there was no way to compare conventional process models side by side.

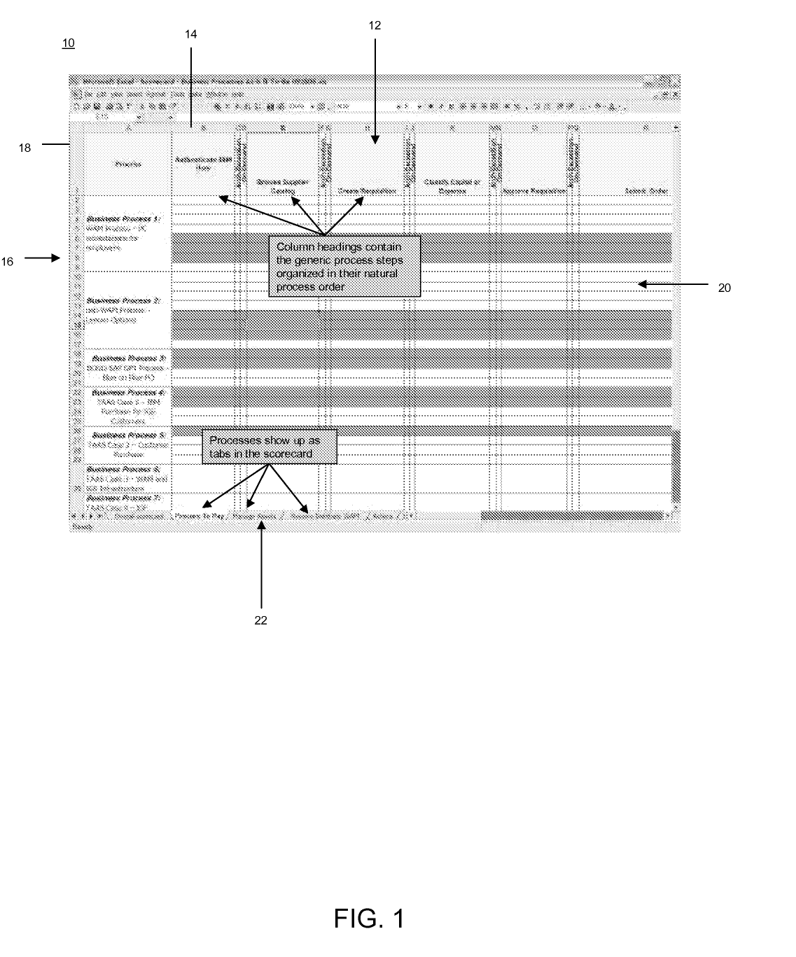

Referring now to FIG. 1, an illustrative business process reference model (hereinafter model 10) according to the present invention is shown. Specifically, model 10 is a tabular model of a process having process steps 12 along a first axis 14 and process variations 16 along a second axis 18, with cells 20 at the intersections of axes 14 and 18. Business Process Reference (Generic) Models provide the primary organizing principle for the method. Each process can exist as part of one or more process families that are represented in model 10 as tabs 22.

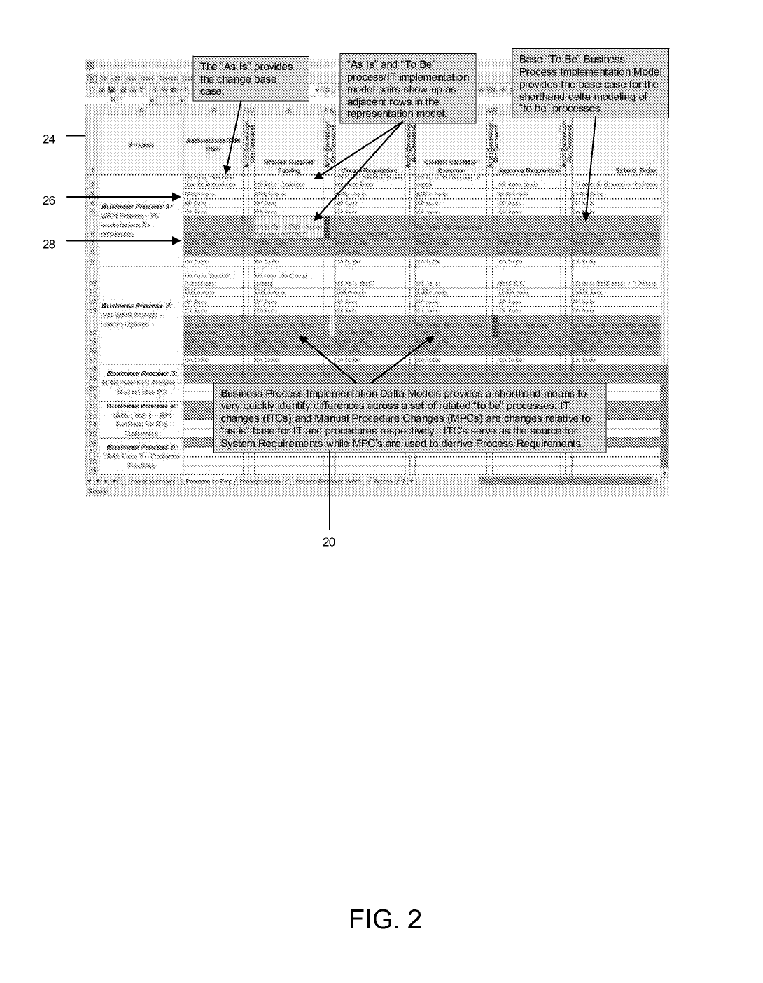

FIG. 2 depicts illustrative business process concepts according to the present invention. Under the present invention, process step details 24 including IT details for a base process are populated into the cells of a first row of the second axis. As further shown, “As Is” and “To Be” process/IT implementation model pairs 26 and 28 show up as adjacent rows in the representation model. The “As Is” business process implementation model 26 provides the change base cases (e.g., pertaining to Information Technology (IT) changes and procedure changes). “To Be” business process implementation model 28 provides the base case for the shorthand delta modeling of “to be” processes. As such, delta details 30 of the process steps for each of the process variations are populated into additional rows of the second axis. One either assigns a specific “To Be” process/IT implementation model as the base case or alternatively may enter the strategic blueprint implementation as the base case.

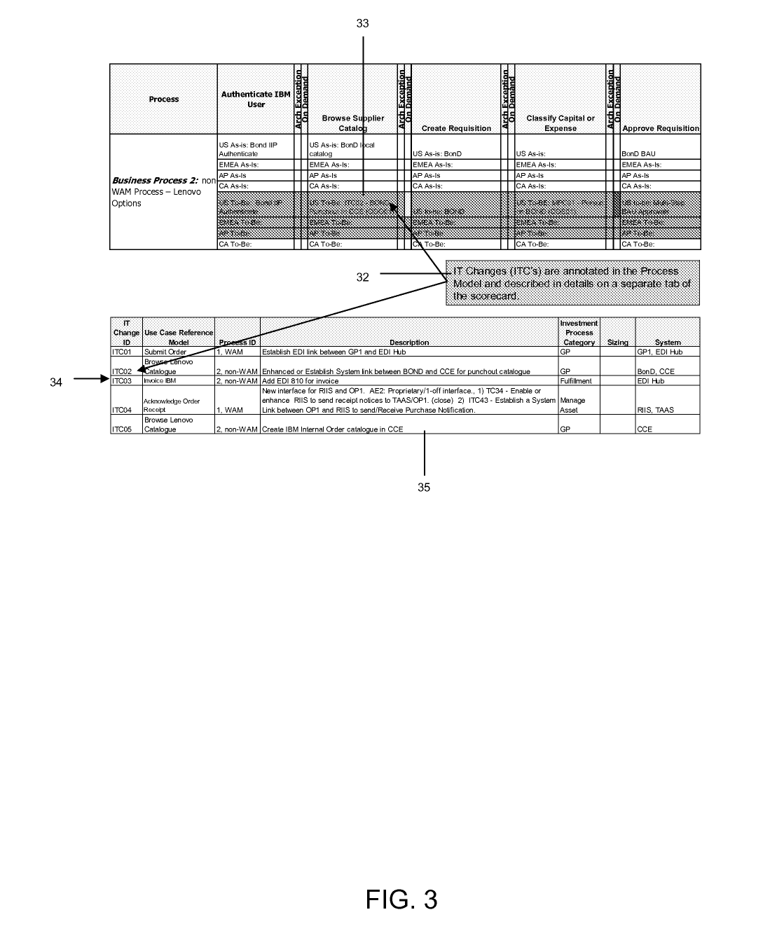

FIG. 3 depicts an illustrative tracking of IT changes according to the present invention. Specifically, IT Changes (ITC's) 32 are annotated 33 (e.g., using ITC codes) in the Process Scorecard Model and described in details 34 on a separate tab 35 of the scorecard. This provides a good way to capture ITC's which are then used as the source for system requirement specifications.

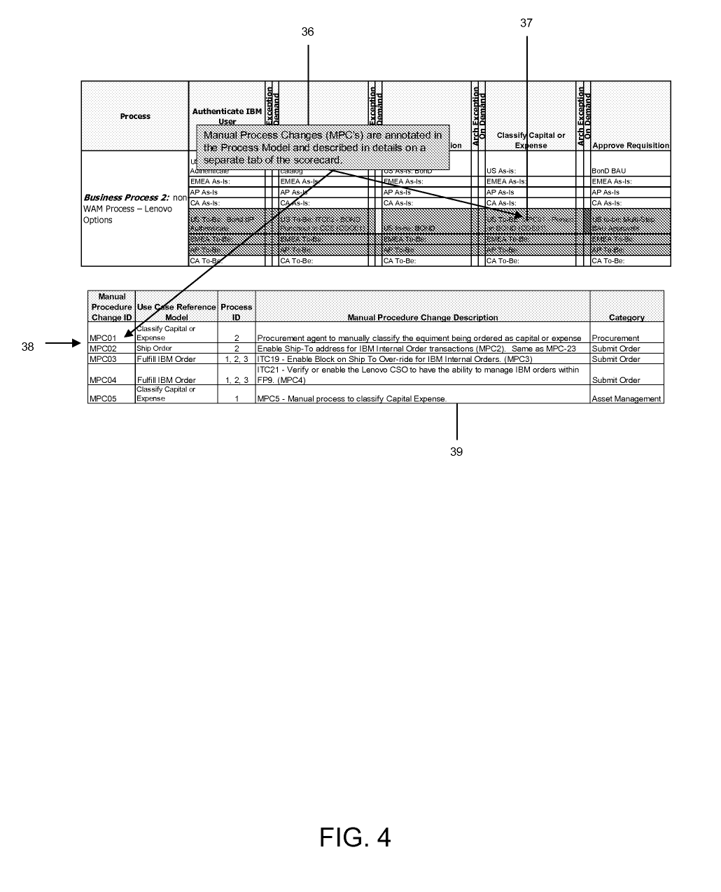

Similarly, process changes 36 are also annotated and described in details, as shown in FIG. 4. Specifically, FIG. 4 depicts Manual Process Changes (MPCs) 36 that are annotated 37 (e.g., using MPC codes) in the cells, with corresponding details 38 described on a separate tab 39 of the scorecard.

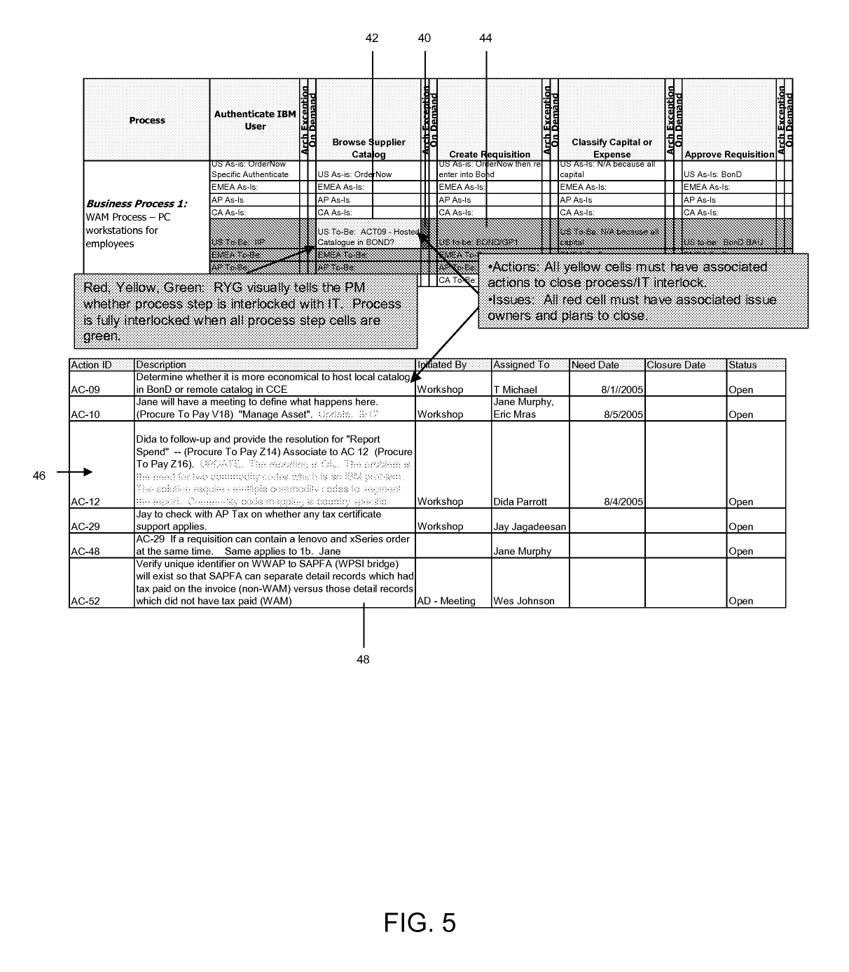

FIG. 5 depicts illustrative project management concepts according to the present invention. Specifically, the present invention allows project management status indicators for each cell denoting statuses of the process steps in each cell to be enabled. In one illustrative embodiment, the project management status indicators comprises some type of visual formatting such as a set of status codes or symbolic annotations, a set of different shadings, a set of colors, etc. In the case of the latter, the following illustrative color set could be used: (1) the color red 40 denoting an issue needing resolution; (2) the color yellow 42 denoting an action being open; and (3) the color green 44 denoting IT interlocks being achieved. Issues and/or actions could be annotated (e.g., using action or issue codes) in the cells. Such annotations would be described in details contained in a separate tab of the scorecard. For example, action codes/identifiers 46 containing details describing actions could be represented in a separate tab 48 of the scorecard.

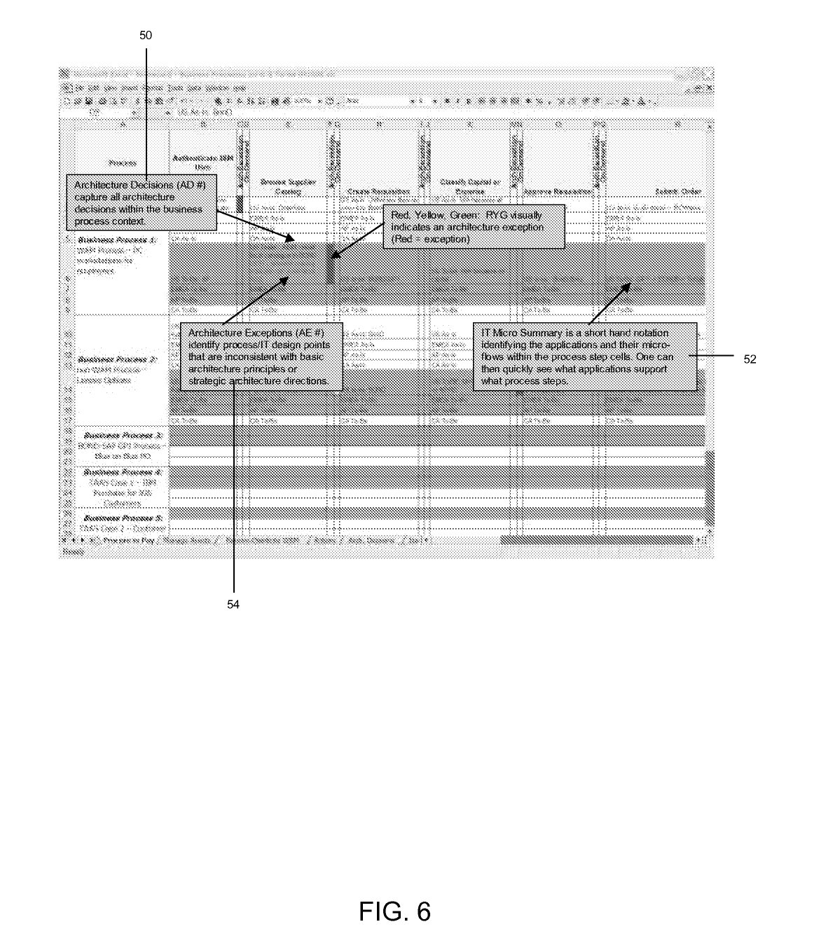

The present invention also allows computer architecture decisions and exceptions to be populated into the cells (e.g., using corresponding codes). FIG. 6 depicts illustrative architecture decision 50 and exception 54 concepts represented in a score card according to the present invention. FIG. 6 also depicts illustrative IT micro summary 52 concepts represented in the scorecard according to the present invention. In general, IT micro summary 52 is a short hand notation identifying the applications and their micro-flows within the process step cells. One can then quickly see what applications support what process steps. Architecture decisions (AD #) 50 capture all architecture decisions within the business process context. Architecture exceptions (AE #) 54 identify process/IT design points that are inconsistent with basic architecture principles or strategic architecture directions.

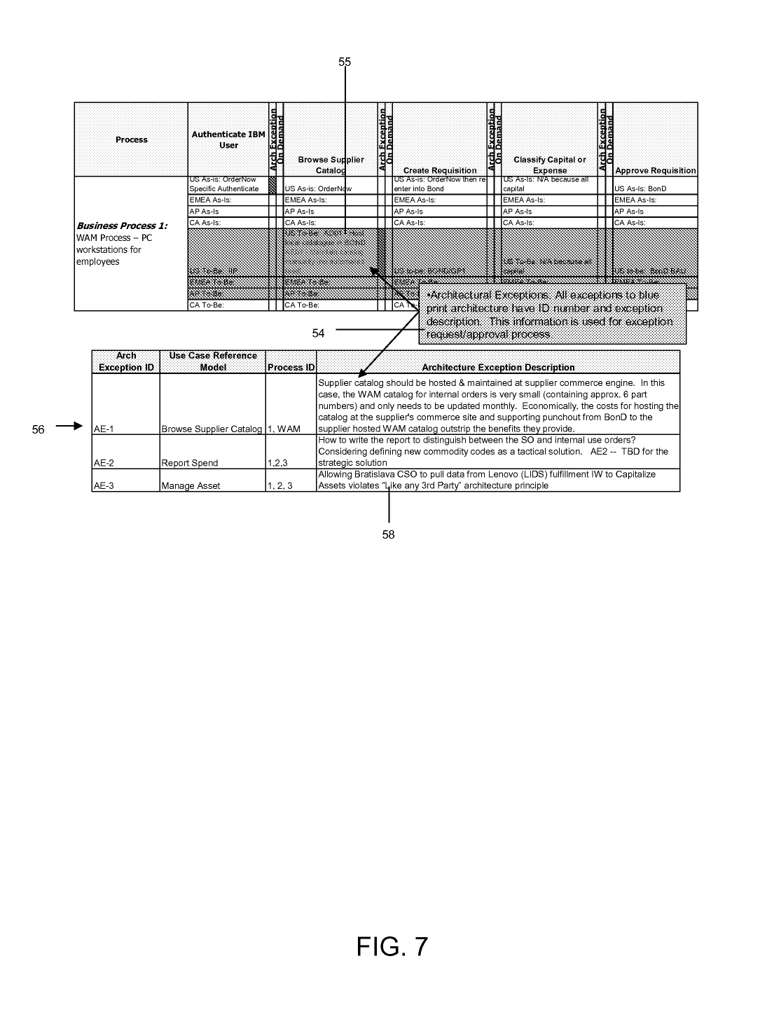

FIG. 7 depicts illustrative annotations 60 and details 56 for architecture exceptions according to the present invention. Specifically, as indicated above, architecture exceptions (as well as decisions) can be annotated (e.g., using architecture exception and decision codes) in the cells. Such annotations 55 are described in details 56 in a separate tab 58 of the scorecard.

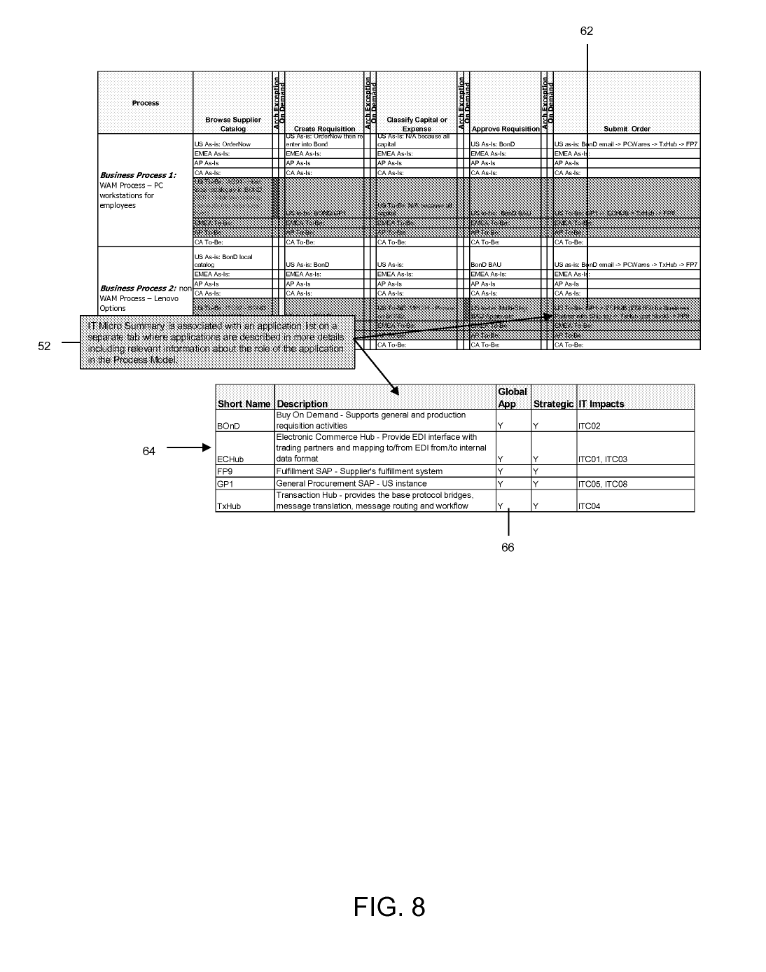

FIG. 8 depicts illustrative annotations 62 and details 64 for IT micro summary 52 concepts according to the present invention. Specifically, as indicated above, IT micro summary 52 is a short hand notation identifying the applications and their micro-flows within the process step cells. This can be can be annotated (e.g., using IT micro summary codes) in the cells. Such annotations 62 are described in details 64 in a separate tab 6 of the scorecard.

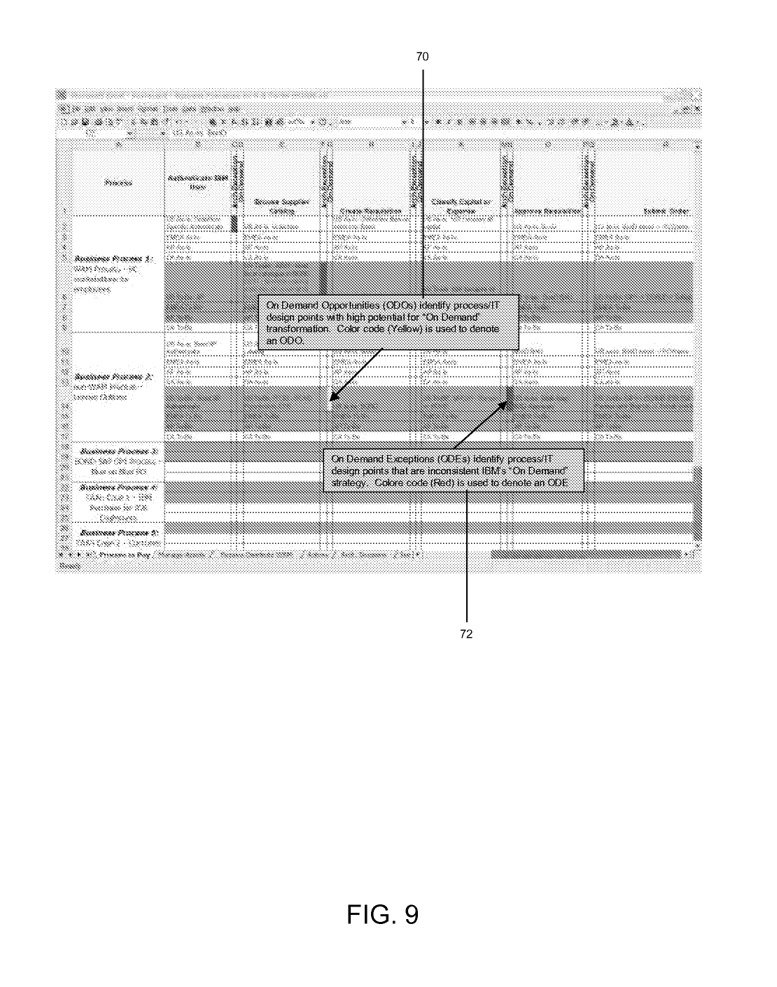

FIG. 9 depicts illustrative on-demand opportunities that are denoted in the cells according to the present invention. Such opportunities include On-Demand Opportunities (ODEs) 72 that identify process/IT design points with high potential for “On-Demand” transformation, and On-Demand Exceptions (ODEs) 74 identify process/IT design points that are inconsistent company “A's” On-Demand” strategy

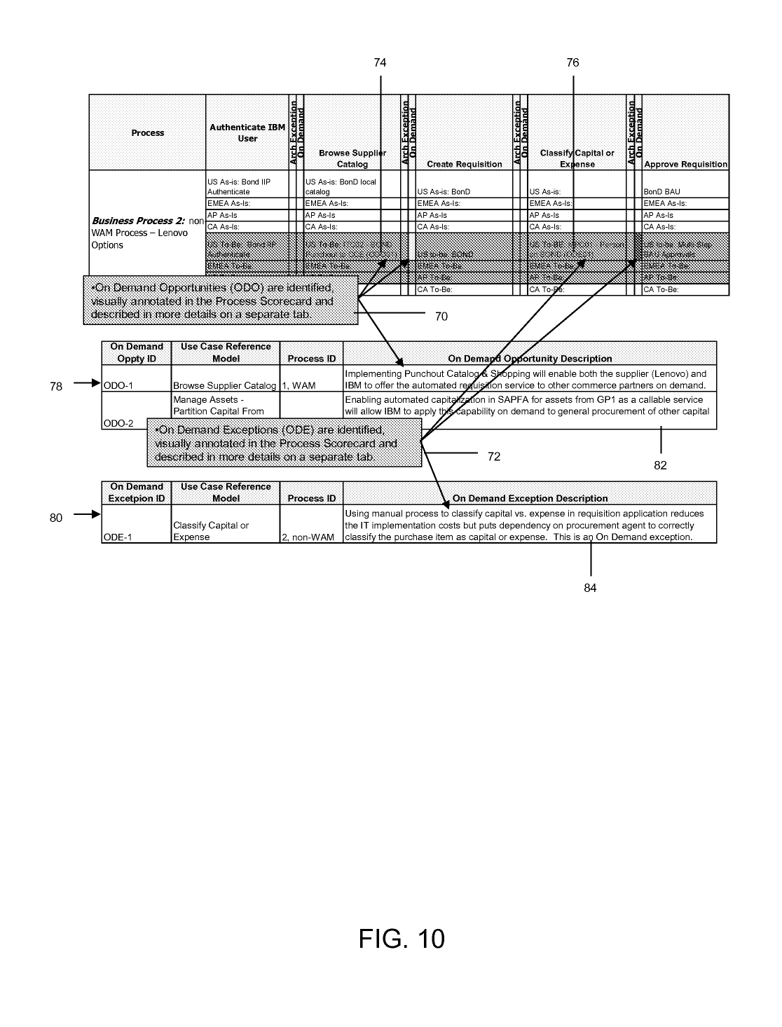

FIG. 10 depicts illustrative annotations 74 and 76 and corresponding details 78 and 80 for on-demand opportunities 70 and exceptions 72 according to the present invention. As shown, details 78 and 80 are described in separate tabs 82 and 84 of the scorecard.

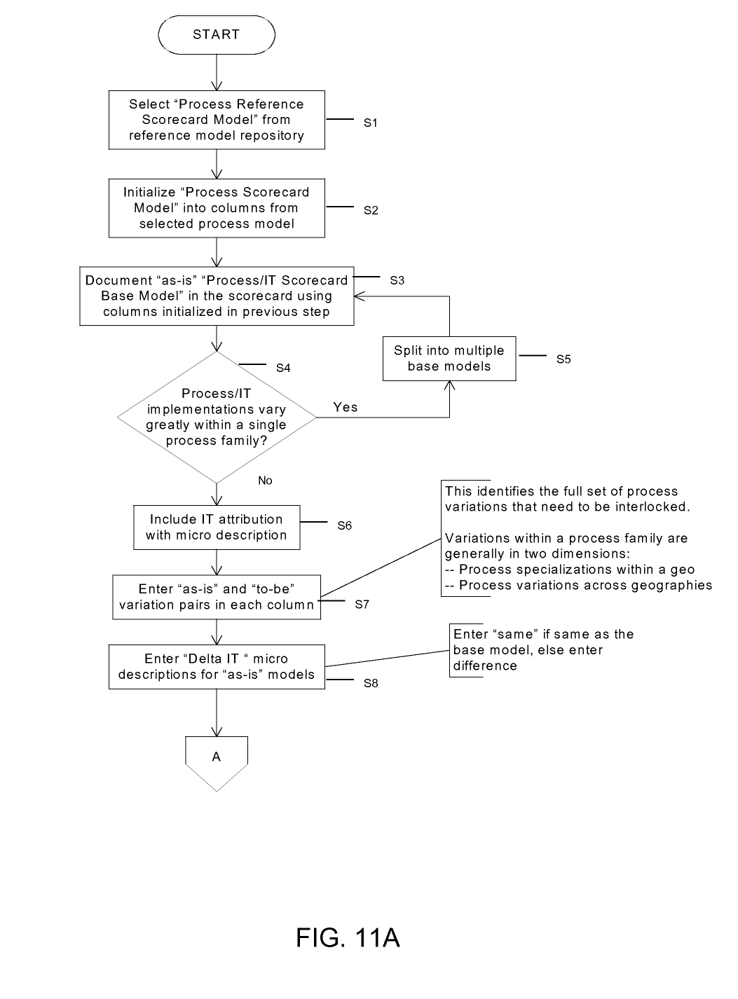

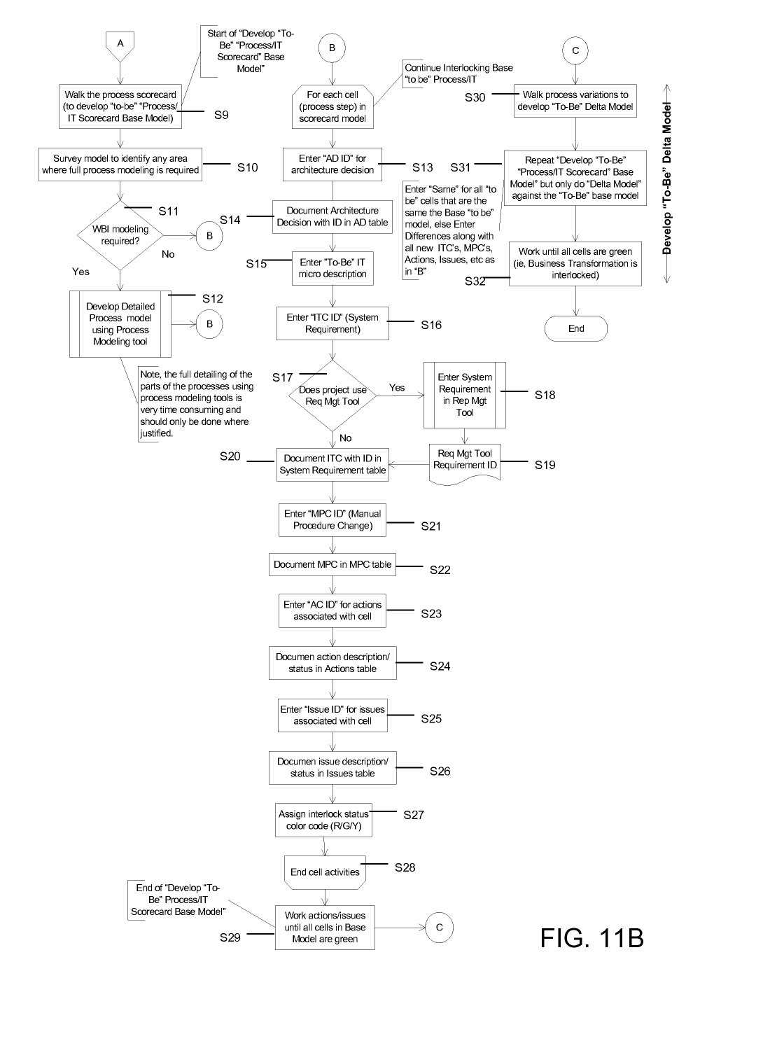

FIGS. 11A-B depicts an illustrative process scorecard model flowchart according to the present invention. Specifically, in step S1 of FIG. 11A, the process reference scorecard model is selected from a reference model repository. In step S2, the process scorecard model is initialized into columns from the selected process model. In step S3, the as-is process/IT scorecard base model/case is documented in the scorecard using the columns initialized in step S2. In step S4, it is determined whether process/IT implementations vary greatly within a single process family. If so, the base model/case is split into multiple base models in step S5. If not, the IT attribution with a micro description is included in step S6. In step S7, as-is and to-be pairs are entered/populated in each column. Then, delta IT micro descriptions are entered/populated in step S8. At that point the method is continued in flow A of FIG. 11B.

In step S9 of FIG. 11B, the process scorecard is walked to develop the to-be process/IT scorecard base model/case. In step S10, the model is surveyed to identify any area where full process modeling is required. In step S11, it is determined whether (e.g., WBI) modeling is required. If not, the method proceeds directly to flow B. If modeling was required, a detailed process model is developed using the process modeling tool in step S12 before proceeding to flow B. In step S13 of flow B, AD ID is entered for architecture decisions for each cell in the scorecard model. In step S14, architecture decisions are documented with their IDs in the AD table. In step S15, the to-be IT micro description is entered/populated. In step S16, the ITC ID is entered. In step S17, it is determined whether the project at hand uses a req. management tool. If so, the system requirement is entered/populated in the rep. management tool in step S18, and the requirement management tool's requirement ID is extracted in step S19. If the project did not use the requirement management tool in step S17, the ITC and ID is documented in the system requirement table in step S20. In step S21, the MPC ID is entered/populated, and the MPC is documented in the MPC table in step S22. In step S23, the AC IDs for actions associated with the cells is entered/populated. In step S24, action descriptions/statuses are documented in the actions table. In step S25, and issue ID for issues associated with the cells is entered/populated. In step S26, issue descriptions/statuses are documented in the issues table. In step S27, interlock status is assigned a color code (or other distinct formatting). In step S28, cell activities are ended, and in step S29, the actions/issues are worked until all cells in the base model reflect total IT interlock (e.g., all cells containing actions or issues are green).

At this point, the method proceeds to flow C. In step S30 of flow C, process variations are walked to develop to-be delta models. In step S31, the process is repeated to develop the to-be process/IT scorecard, but only for comparing the delta model against the to-be base model. In step S32, work is continued until all cells are green (i.e., the business transformation is interlocked.

While shown and described herein as process management and IT interlock solution, it is understood that the invention further provides various alternative embodiments. For example, in one embodiment, the invention provides a computer-readable/useable medium that includes computer program code to enable a computer infrastructure to manage a process and IT interlock. To this extent, the computer-readable/useable medium includes program code that implements each of the various process of the invention. It is understood that the terms computer-readable medium or computer useable medium comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a device (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process of the invention on a subscription, advertising, and/or fee basis. That is, a service provider, such as a Solution Integrator, could offer to manage a process and IT interlock. In this case, the service provider can create, maintain, deploy, support, etc., a computer infrastructure that performs the process of the invention for one or more customers. In return, the service provider can receive payment from the target organization(s) under a subscription and/or fee agreement and/or the service provider can receive payment from the sale of advertising content to one or more third parties.

In still another embodiment, the invention provides a computer-implemented method for managing a process and IT interlock. In this case, a computer infrastructure can be provided and one or more systems for performing the process of the invention can be obtained (e.g., created, purchased, used, modified, etc.) and deployed to the computer infrastructure. To this extent, the deployment of a system can comprise one or more of (1) installing program code on a device such as controlling and/or controlled computers, from a computer-readable medium; (2) adding one or more devices to the computer infrastructure; and (3) incorporating and/or modifying one or more existing systems of the computer infrastructure to enable the computer infrastructure to perform processes according to one or more aspects of the invention.

As used herein, it is understood that the terms “program code” and “computer program code” are synonymous and mean any expression, in any language, code or notation, of a set of instructions intended to cause a device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular providing and/or I/O device, and the like.

Aspects of the invention can take the form of an entirely software embodiment or an embodiment containing both hardware and software elements. In an embodiment, aspects of the invention are implemented in software, which includes but is not limited to firmware, resident software, microcode, etc. Furthermore, aspects of the invention can take the form of a computer program product accessible from at least one computer-usable or computer-readable medium storing program code for use by or in connection with a computer or any instruction execution system. For the purposes of this description, a computer-usable or computer readable medium can be any tangible apparatus that can contain, store, communicate, propagate, and/or transport the program for use by or in connection with the instruction execution system, apparatus, device, and/or the like.

The medium can be an electronic, magnetic, optical, electromagnetic, infrared, or semiconductor system (or apparatus or device), a propagation medium, and/or the like. Examples of a computer-readable medium include, but are not limited to, a semiconductor or solid state memory, magnetic tape, a removable computer diskette, a random access memory (RAM), a read-only memory (ROM), a rigid magnetic disk and an optical disk. Current examples of optical disks include, but are not limited to, compact disk-read only memory (CD-ROM), compact disk-read/write (CD-R/W) and DVD.

A data processing system suitable for storing and/or executing program code can include at least one processor communicatively coupled, directly or indirectly, to memory element(s) through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output or I/O devices (including, but not limited to, keyboards, displays, pointing devices, etc.) can be coupled to the system either directly or through intervening I/O controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems and Ethernet cards.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A method for managing a process and IT interlock, comprising the steps of:
constructing a tabular model of a process having process steps along a first axis and process variations along a second axis, with cells at the intersections of the axes;
populating process step details including IT details for a base process into the cells of a first row of the second axis;
populating delta details of the process steps for each of the process variations into additional rows of the second axis; and
enabling project management status indicators for each cell denoting statuses of the process steps in each cell.

2. The method of claim 1, the tabular model being realized and displayed by a spreadsheet program.

3. The method of claim 1, the process being part of a process family, and the process family being represented by different tabs of the tabular model.

4. The method of claim 1, further comprising populating as-is base cases into the cells, the as-is base cases pertaining to Information Technology (IT) changes and procedure changes.

5. The method of claim 4, the delta details comprising to-be base cases.

6. The method of claim 1, the project management status indicators comprising a set of colors, the set of colors comprising red denoting an issue needing resolution, yellow denoting an action being open, and green denoting IT interlock being achieved.

7. The method of claim 1, further comprising populating computer architecture decisions and exceptions into the cells.

8. The method of claim 1, further comprising populating an IT micro summary into the cells, the IT micro Summary identifying applications and their micro-flows within the process steps.

9. The method of claim 1, further comprising denoting on-demand opportunities in the cells.

10. A system for managing a process and IT interlock, comprising the steps of:
means for constructing a tabular model of a process having process steps along a first axis and process variations along a second axis, with cells at the intersections of the axes;
means for populating process step details including IT details for a base process into the cells of a first row of the second axis;
means for populating delta details of the process steps for each of the process variations into additional rows of the second axis; and
means for enabling project management status indicators for each cell denoting statuses of the process steps in each cell.

11. The system of claim 10, the system comprising a spreadsheet program, the process being part of a process family, and the process family being represented by different tabs of the tabular model.

12. The system of claim 10, further comprising means for populating as-is base cases into the cells, the as-is base cases pertaining to Information Technology (IT) changes and procedure changes.

13. The system of claim 12, the delta details comprising to-be base cases.

14. The system of claim 10, the project management status indicators comprising a set of colors, the set of colors comprising red denoting an issue needing resolution, yellow denoting an action being open, and green denoting IT interlock being achieved.

15. The system of claim 10, further comprising:
means for populating computer architecture decisions and exceptions into the cells;
means for populating an IT micro summary into the cells, the IT micro Summary identifying applications and their micro-flows within the process steps; and
means for denoting on-demand opportunities in the cells.

16. A program product stored on a computer readable medium for managing a process and IT interlock, the program product comprising program code for causing a computer system to:
construct a tabular model of a process having process steps along a first axis and process variations along a second axis, with cells at the intersections of the axes;
populate process step details including IT details for a base process into the cells of a first row of the second axis;
populate delta details of the process steps for each of the process variations into additional rows of the second axis; and
enable project management status indicators for each cell denoting statuses of the process steps in each cell.

17. The program product of claim 16, the program product comprising a spreadsheet program, the process being part of a process family, and the process family being represented by different tabs of the tabular model.

18. The program product of claim 16, the program product further comprising program code for causing the computer system to populate as-is base cases into the cells, the as-is base cases pertaining to Information Technology (IT) changes and procedure changes, and the delta details comprising to-be base cases.

19. The program product of claim 16, the project management status indicators comprising a set of colors, the set of colors comprising red denoting an issue needing resolution, yellow denoting an action being open, and green denoting IT interlock being achieved.

20. The program product of claim 16, the program product further comprising program code for causing the computer system to:
populate computer architecture decisions and exceptions into the cells;
populate an IT micro summary into the cells, the IT micro summary identifying applications and their micro-flows within the process steps; and
denote on-demand opportunities in the cells.
